(19) United States
(12) Patent Application Publication
(10) Pub. No.: US 2007/0136433 A1
(43) Pub. Date: Jun. 14, 2007

(54) Intelligent buffer and related applications

(76) Inventors: Laurence J. Booton, Woodbridge (GB); Derek J. Emerson, Ipswich (GB); Martyn Russell, Ipswich (GB)

Correspondence Address: NIXON & VANDERHYE, PC, 901 NORTH GLEBE ROAD, 11TH FLOOR, ARLINGTON, VA, 22203, US

(21) Appl. No.: 10/581,996

(22) PCT Filed: Dec. 10, 2004
(86) PCT No.: PCT/GB04/05209

§ 371 Date: Jun. 7, 2006

(30) Foreign Application Priority Data
Dec. 11, 2003 (GB) 0328760.4

(51) Int. Cl. G06F 15/167

(52) U.S. Cl. 709/213

(57) ABSTRACT

An integrated communications application reads information copied to a shared buffer by a user from another application. The information copied can comprise any format and can originate from any application from which the user can paste information. In this way there is no restriction on the source of information. The computer application reads the buffer and copies the information so that it can subsequently process it to determine if it conforms to a predetermined data-type. One or more means to communicate with an entity whose address corresponds to the data-type are then determined from a single data-type. This enables the application to revert to an alternative means of communication automatically if the means first used to try to communication with the entity is not successful. More generally, the computer application is arranged for use in a computer communications environment and comprises: means arranged to read information stored in a buffer, the buffer arranged to be shared between a plurality of applications in said computing environment; and means arranged to process said information to determine if the information can be determined to comprise one or more of a plurality of data-types.

The present invention relates to an intelligent buffer and related applications. In particular, but not exclusively, the invention relates to a method of communication which uses an intelligent buffer reader to automatically extract information copied by a user to a buffer to enable the information extracted to be shared between different applications arranged to run on the user's computer. The extracted information is then processed to determine one or more appropriate modes of communication with one or more entities, for example by automatically emailing an entity or dialling the telephone number of an entity in a computer-telephony environment.

Whilst the intelligent buffer can be used in a computer-telephony environment, it is not limited thereto. However, several mechanisms to facilitate communication in a computer-telephony environment are already known in the art. For example, U.S. Pat. No. 6,594,357, “System and method of registering the identity of a telephone terminal in association with the identity of a computer terminal” describes a means to associate a computer terminal with a telephone terminal to form a computer-telephony environment. In such environments, a computer application can be used to dial a telephone number. Known technologies require the computer terminal to be presented with a telephone number in an appropriate format, however, such that an application running on the computer terminal can be activated to dial the telephone number. For example, a “one-click” application can be implemented in a computer-telephony environment such as U.S. Pat. No. 6,594,357 describes. Such an application enables a user to look an entity up in an on-line directory, and, providing the user has activated the “one-click” service, if the entity to be called has a “one-click” telephone number activated in the directory, the user can simply click with their mouse on the telephone number and be connected to the entity over the telephone.

However, this technology has a drawback in that it requires the entity (i.e., the called party) to be represented in a directory (i.e., database) in a predetermined format which the user's dialling application can recognise to determine the number to be dialled. Moreover, if telephone number for the entity is displayed to the user it must be appropriately associated with the dialling application so that this application is activated. Accordingly, the dialled number must be associated directly with the application used to dial the number by the directory or database which the user uses to look up the dialled number when the directory database is generated. The user cannot simply click on any telephone number in any application they are using and still activate a dialling application to call the telephone number the user has clicked on using known techniques.

One way to associate particular applications with certain text strings is the hypertext link. Hypertext links are well known to provide shortcuts to particular applications. If certain text strings appear to conform to one-or more predetermined formats, it is possible to indicate that they are text strings to be activated as links to other applications. However, this requires the creator of the document to indicate that the text strings should be treated as such.

Another way to identify when certain text should be treated as a link to another application uses “tags” as indicators. The provision of a tag removes the need for a user to scan through the text to determine the context of certain text strings (e.g., if the text string selected is a URL, if it is a telephone number etc.). Microsoft™ have developed the Microsoft™ Smart Tag™ technology, which is a sophisticated application which enables information content to be intelligently scanned for presentation to a user for further action using open hypermedia generic links. The Smart Tag™ is well known in the art and is limited to all relevant applications being Microsoft™ applications. The use of the Smart Tag™ tags can create a loss of control over presentation of the document, as it can alter the way in which certain text is presented in a document. To prevent content enabled from a web-based server from being altered locally and presented differently from how the author intended a user needs to positively activate the Smart Tag™ technology.

United States Patent Application No. US 2003/059109 entitled “Method and Apparatus for providing Application Integration on a Web Browser” by Rossman et al, describes a method of processing a web-page to classify the content of the web-page as including a number of predetermined data-types. A number of related operations are determined for each classified data type.

The techniques described in US Patent Application No. Us 2003/059109 are limited in that a user is only presented with an operation associated directly with the data type classified from the web-page. Moreover, as data-types are determined directly from the web-page, the user has no control over what data-types are classified or how many data-types are determined from each web-page. For example, if a web-page happens to contain a large number of data-types (consider a school-year book type web-site with several hundred names and addresses on a single web-page) the user and the application resources classifying the data can be overwhelmed.

The invention seeks to provide a method for communicating with an entity within a computer-telephony environment which mitigates and/or obviates the limitations of the prior art. A communication integration application is provided which enables a user to have more control over which information is automatically associated with specific applications and yet which does not compromise the originally intended presentation of the information.

The invention further seeks to provide a communication integration application which enables a particular data-type to be extracted from an application to be associated with one or more means of communicating with an entity associated with the data-type. More than one means of communication with an entity can be determined from an identified data-type by using the identified data-type as a means to locate appropriate records for the entity held in one or more databases with which the communications integration application is arranged to interface. One or more of said means of communicating with the entity can be initiated either automatically by the communication integration application in response to one or more criteria being met or directly by the user. A priority order can be configured by the user to determine the order in which communications means should be used to contact an entity, for example, if no contact is made using a line-line telephone, automatically redial the entity's mobile number, if a busy signal is detected for the entity's mobile device, then automatically generate an interface for the user to send the entity a small message service text message to the mobile, alternatively, if the entity's mobile device does not answer, open an electronic mail application on the user's client terminal to enable the user to email the entity. The user can be prompted to send the e-mail with a voice mail message sent as an attachment to the email, and/or to enter text in the body of the e-mail, and/or to have their vocal message converted appropriately into text to send in the body of the e-mail.

Advantageously, as less information needs to be processed by the communication integration application, more sophisticated and/or faster processing of the textual information can be performed.

### SUMMARY STATEMENTS OF INVENTION

According to a first aspect of the invention there is provided an integrated communications application, arranged for use in a communications environment, the application arranged to associate one or more means of communicating with one or more entities with information selected by a user in another application operating in the same environment as the integrated communications application, the information being copied by the user to a shared memory buffer, wherein the other application is configured to at least write to the said shared memory buffer and the integrated communications application is configured to at least read from the said shared memory buffer, the integrated communications application further comprising: means arranged to extract selected information from the shared buffer; and means arranged to process said extracted information to determine if the user selected information can be determined to comprise one or more of a plurality of data-types.

The information may contain textual and/or visual and/or audio information. The information is capable of being associated with a communications address for an entity.

One or more of a plurality of data-types may comprise communications-related data-types and are associated with means to communication with said one or more entities. One or more of a plurality of data-types represent an identifiable characteristic of an entity.

Another related aspect of the invention provides a computer application, arranged for use in a computer communications environment, the computer application comprising: means arranged to read information stored in a buffer, the buffer arranged to be shared between a plurality of applications in said computing environment; and means arranged to process said information to determine if the information can be determined to comprise one or more of a plurality of data-types. The computer application may comprise a suite of one or more software programs and/or components of hardware as are required to implement the invention. The application may be distributed across a computer system comprising a computer terminal which a user is operating and one or more remote server systems. The application may further extend to software and/or hardware enabling said means to process the information to access remote data-base facilities. The remote data-base facilities may be pre-determined and may be proprietary or public.

Preferably, one or more of said plurality of data-types comprises an identified communicable entity. For example, a communicable entity could be a firm or business entity or an individual.

Preferably, one or more of said plurality of data-types comprises a means of communicating with an entity. For example, a means of communicating with an entity could comprise a postal address, a telephone number to be dialled, an email address, a web-site URL, a file-transfer protocol address etc.

A second aspect of the invention seeks to provide a method of communicating with an entity, the method comprising: a user operating a terminal to open an application which displays textual information on a screen; the user selecting a text-string from the displayed textual information; the user copying the text-string to a buffer available to at least one other application; determining if the text string in the buffer conforms to a predetermined data-type associated with an entity; and in the event the predetermined data-type associated with an entity comprises an identified means to communicate with the entity, initiating communication with the entity using said means to communicate; and otherwise in the pre-determined data-type comprises an identified entity, initiating communication with the entity using a predetermined means to communicate.

For example, if said predetermined data type associated with the entity comprises the telephone number then the identified means to communicate with the entity comprises the telephone number and the step of initiating communication using the telephone number comprises dialling the telephone number.

In said step of determining if the text-string conforms to a predetermined data-type, the text-string in the buffer may be read and another application used to determine if the text-string conforms to a predetermined data-type associated with an entity. Preferably, the buffer contents are read and copied by said other application into its own memory means.

Preferably, the step of initiating communication with the entity using said means to communicate comprises automatically using said means to communicate without further action by the user. Alternatively, the step of initiating communication may be controlled by the user performing an additional action.

The predetermined means to communicate may be configured such that a set of predetermined preferences are established by the user which are used to determine a default predetermined means to communicate with the entity and/or a default means of communication can be determined by the user.

The method may further comprise a step of associating-the means of communication determined from the data-type with another means of communication, and in said step of initiating communication use said other means of communication.

A third aspect of the invention seeks to provide a method of enabling a user to select an action to be performed on information selected by the user, the method comprising the steps of: the user selecting the information; and automatically determining if the selected information conforms to a predetermined set of format rules; processing the information items conforming to said predetermined set of format rules; associating each said one or more processed information items with one or more communication options; associating each communication option with an application enabling said communication option to be activated.

The communication option may be activated by a single user-determined action. The single user-determined action may be a single activation click by a computer mouse-type device. The single user-determined action may be a key press or a combination of key presses on a computer keyboard. The single user-determined action may be a voice command. The user may select the information by storing the selected information in a memory store. The user may select the information by dragging and dropping the information into a suitable application interface.

The application enabling said communication option to be activated may comprise a click-dial type application. Click-dial applications enable a user to activate a dialling application to dial a telephone number by clicking on text representing the telephone number in an integrated computer-telephony environment and are described in literature published by British Telecommunications and in U.S. Pat. No. 6,594,357.

Preferably, each information item is associated with a communication option by reference to a database selected from a set of one or more databases.

Preferably, said communication option is further associated with a second communication option by reference to a database selected from a set of one or more databases.

A fourth aspect of the invention seeks to provide a suite of one or more computer programs which when executed alone or collectively are arranged to implement steps in any method according to the invention.

A fifth aspect of the invention seeks to provide a client application comprising software arranged to implement steps in a method according to any appropriate aspect of the invention in a distributed computer system.

A distributed computer system comprising a client terminal and a database facility, the client terminal being arranged to implement steps in a method according to any suitable aspect of the invention, whereby said steps of associating said one or more information items are performed by said client terminal communicating said information items to said database to enable at least one database record structure to be determined associated with a said information item to derive at least one communication option associated by a said record with said a said information item.

Preferably, said information item comprises a telephone number associated with an entity, and said communication option comprises an alternative method of contacting said entity.

Preferably, said alternative method of contacting said entity comprises selecting an action to be performed on the following information item: an alternative telephone number.

Preferably, said alternative method of contacting said entity comprises selecting an action to be performed on the following information item: an electronic mail address.

Preferably, said alternative method of contacting said entity comprises selecting an action to be performed on the following information item: an instant messenger address.

Preferably, said alternative method of contacting said entity comprises selecting an action to be performed on the following information item: a postal address.

Preferably, said alternative method of contacting said entity comprises selecting an action to be performed on the following information item: an internet URL associated with the entity.

Any combination of the above mentioned information items may be presented to the user for selection.

For example, an information item may comprise an entity's name, and said method of communication may comprise dialling at least one telephone number for the entity. If said method of communication comprises dialling a telephone number for the entity and a message is left by the caller, the message may also be recorded and the recorded message subsequently presented for communication by electronic mail to the intended recipient. The message may be converted to text and included in the electronic mail. Alternatively, the message is attached to the electronic mail in an audio format.

A list of information items may be generated for each entity to be contacted, each information item being associated automatically with at least one means of contacting the entity, whereby the user is able to select an information item and/or its associated communication option a contact the entity by a single action performed on the representation of the communication option provided graphically to the user.

A user may be able to select a plurality of information items, each item having the same type of communication option and is able to contact simultaneously all entities so selected using a suitably modified version of said communication option.

A user may be able to select to conference call several entities in a telephone call by simultaneously selecting said plurality of entities with a single action.

A user may be able to select to electronically email several entities by selecting information whose filtered information items generates an email communication option for said several entities.

Another aspect of the invention seeks to provide a method of integrating communication means in a computer-telephony environment, the method comprising: processing a text-string derived from textual information a user has selected to copy to a shared buffer application; determining if the text string in the buffer conforms to a predetermined data-type associated with an entity by comparing the text-string with textual information associated with the predetermined data-base, the textual information comprising a component of a record stored in database; and in the event a predetermined data-type is associated with an entity, if the data-type is associated with an identified means to communicate with the entity, initiating communication with the entity using said associated means to communicate and the text-string selected by the user; and otherwise, if the pre-determined data-type comprises an identified entity, initiating communication with the entity using a predetermined means to communicate determined by further associating the data-type with a data-type associated with said predetermined means to communicate.

Preferably, a data-type is associated with a plurality of means to communicate with the entity, and each said communication means are initiated in a predetermined order if the first communications means initiated is not successful in establishing communication with the entity.

One aspect of the invention seeks to provide a memory-facility capable of determining from the context of information copied into the memory-facility, a communications address an associated mode of communicating with said communications address.

In one embodiment of the invention, the memory-facility is dynamic, for example, it may be implemented in a random-access memory store, for example, a buffer memory and/or provided by a first-in, first-out memory storage facility.

In another aspect of the invention, a memory-facility is arranged to enable a user operating a user-terminal to communicate with at least one entity using one or more communication means associated with said user-terminal, the memory-facility being arranged to interface with a plurality of applications whose operation is supported by said user-terminal, wherein one of said plurality of applications comprises a communications application arranged to associate one or more communication means with information selected by said user from information provided by one or more others of said plurality of applications, the memory-facility comprising: memory means arranged to store information selectively copied by the user and written to said shared memory by said one or more others of said plurality of applications; and means arranged to share said memory with at least said communications application and to enable said communications application to read information from the said shared memory, said read information enabling at least one available communication means to be selected by the communications application to enable the user communicate with said entity.

In one embodiment, the read information enables at least one available communications means to be automatically selected by the communications application.

In one embodiment, the information selected by the user comprises textual information.

In one embodiment, the information selected by the user comprises an image.

In one embodiment, the read information comprises selected information and said buffer facility further comprises: means arranged to extract selected information from the shared buffer; and means arranged to process said extracted information to determine if the user selected information can be determined to comprise one or more of a plurality of data-types.

Another aspect of the invention relates to a method of communicating with one or more entities using a terminal operated by a user and capable of forming one or more connections to a communications network, the method comprising the steps of: the user selecting information from a display; copying the selected information to a buffer; processing the information to determine from the context of the copied information, a communications address for each of said one or more entities; and automatically initiating a communications application associated with each communications address identified, to enable the user to communicate with said one or more entities.

In one embodiment, at least one communications address comprises one of the following: an email address; a telephone number; a video-communications address.

In one embodiment, the selected information copied comprises a text-string.

In one embodiment, the selected information copied includes an image (which may or may not be selectively copied with textual information). The image may be capable of being associated with at least one communications address.

In another aspect of the invention, an intelligent buffer is provided in which the buffer is arranged to receive a text-string selected by a method according to the previous aspect.

Thus the invention provides an intelligent communications system and related aspects in which communications is initiated via a terminal operated by a user, and in which the mode of communication initiated by the terminal to communicate with a called party is determined from the context of information selected by the user from information provided on a display associated with the terminal.

Any of the above aspects of the invention (or independent claims) can be combined with any appropriate embodiments (e.g. preferred features and/or dependent claims), in any appropriate manner apparent to those skilled in the art.

The preferred embodiments of the invention will now be described with reference to the accompanying drawings which are by way of example only and in which:

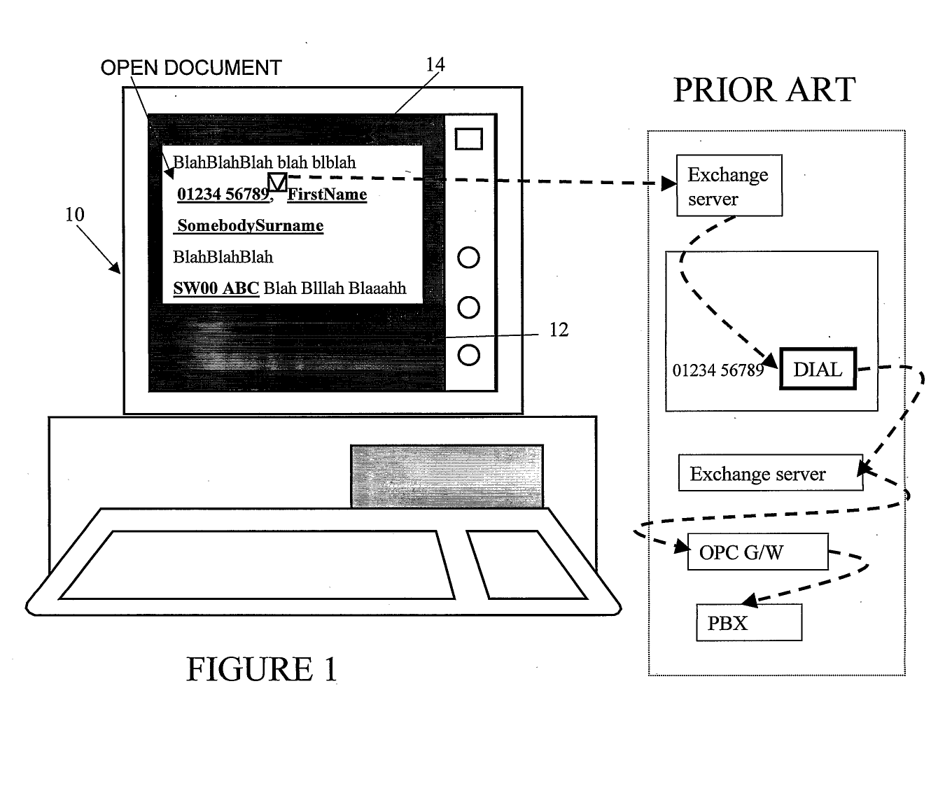

FIG. 1 is a schematic diagram of an example of the Smart Tag™ scheme for determining a data type and associating it with an application;

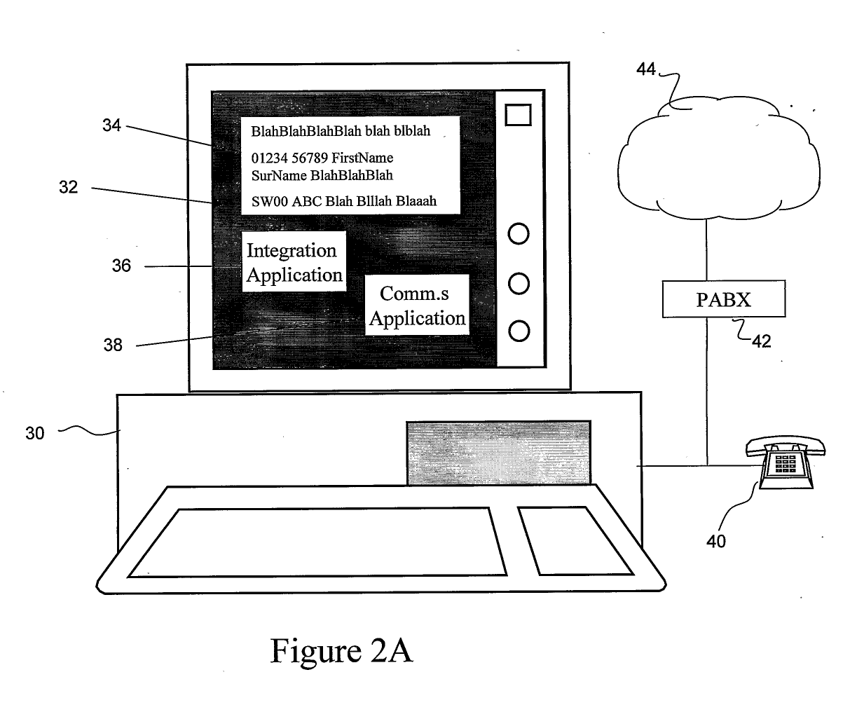

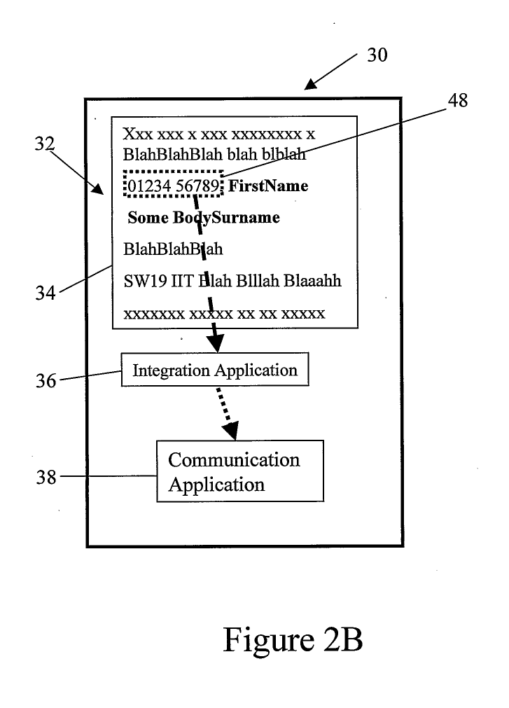

FIG. 2a is a schematic diagram showing a computer-telephony embodiment of the invention;

FIG. 2b is a schematic diagram showing in more detail the relationship between the applications shown schematically in FIG. 2a;

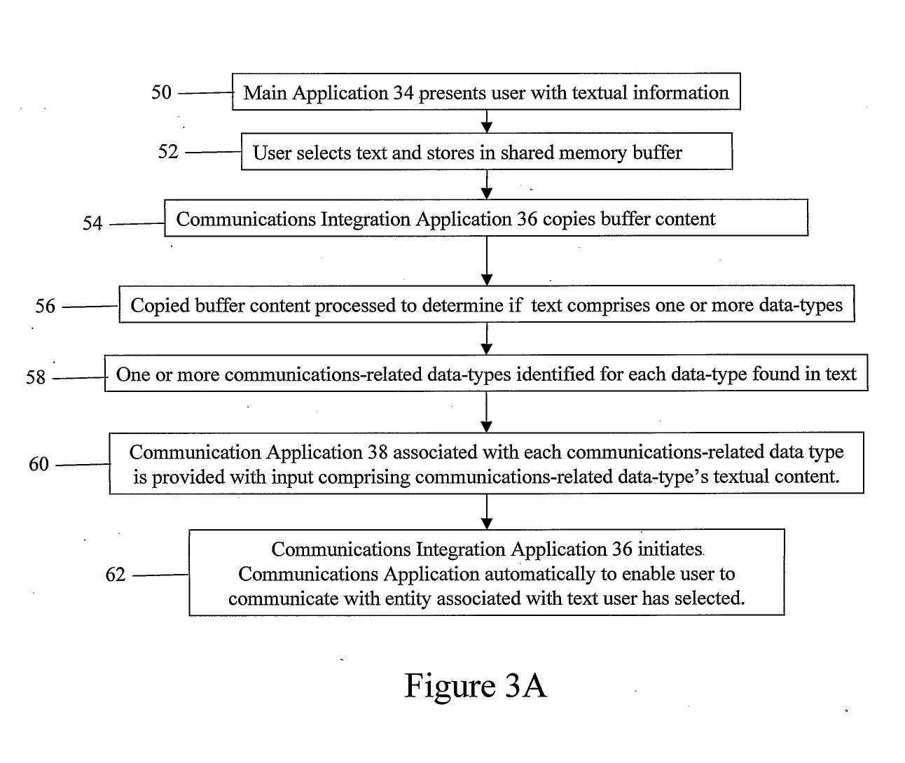

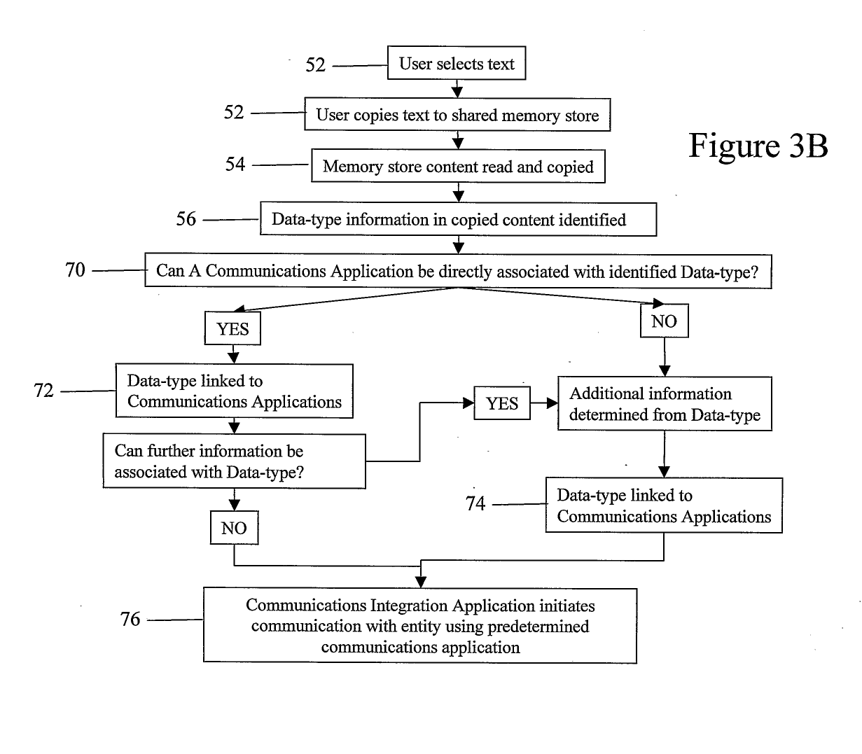

FIG. 3a is a schematic diagram showing steps in an embodiment of the invention;

FIG. 3b is a schematic diagram showing additional steps in another embodiment of the invention;

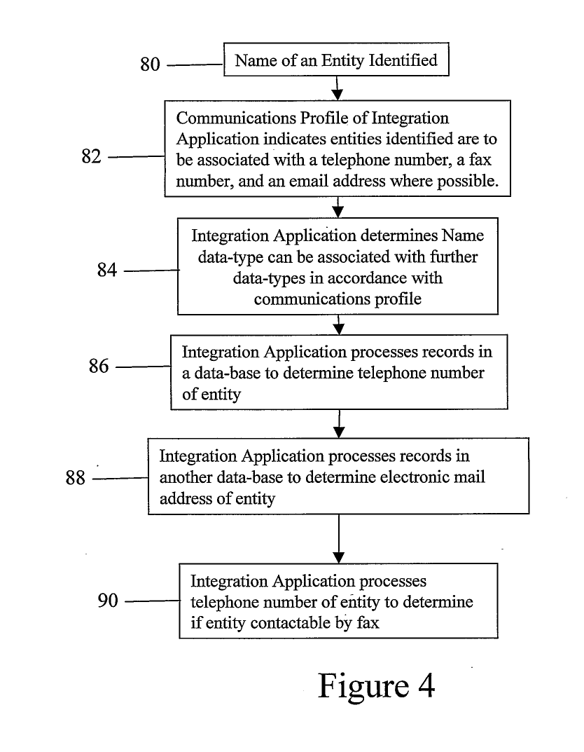

FIG. 4 is a schematic diagram showing steps in another embodiment of the invention;

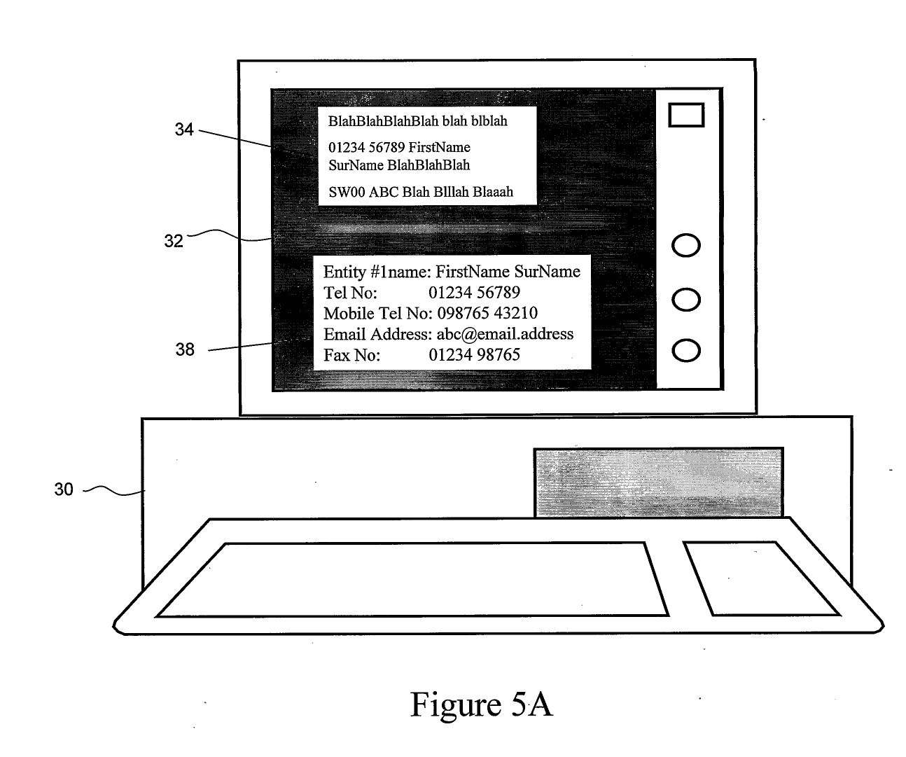

FIGS. 5A and 5B are schematic diagrams showing screen displays associated with alternative embodiments; and

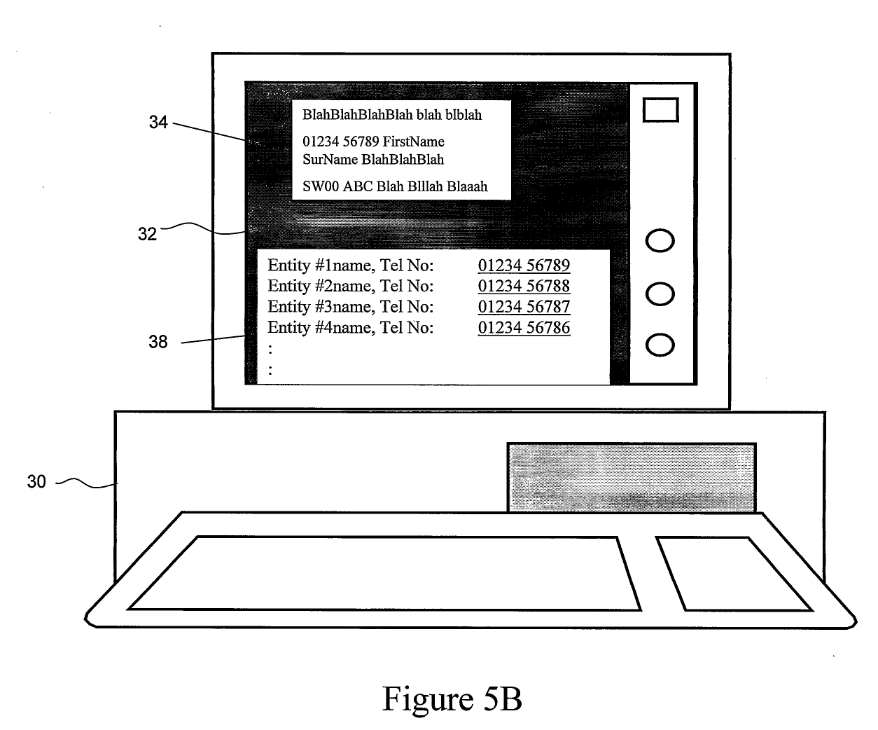

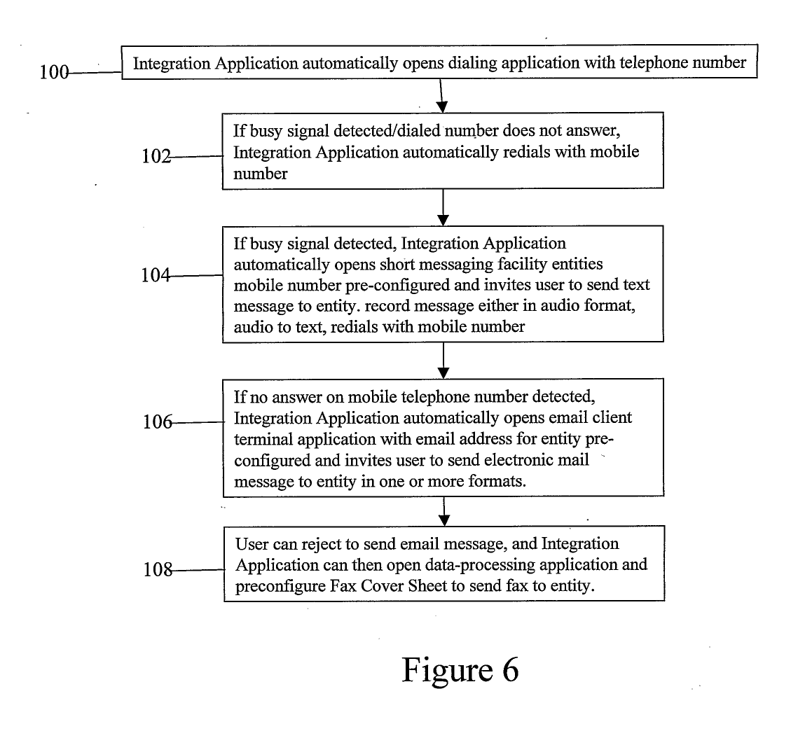

FIG. 6 is a schematic diagram showing steps in another embodiment of the invention.

The best mode of the invention as currently contemplated by the inventor will now be described with reference to the prior art shown in FIG. 1. Those skilled in the art will appreciate that the drawings are simplified schematics of the prior art and the invention. Those skilled in the art will recognise that certain features whose omission does not hinder comprehension of the prior art or the invention have been omitted from the drawings for the sake of clarity.

FIG. 1 shows a schematic diagram of an example of how the Smart Tag™ scheme for linking a data-type with an application could be implemented. In FIG. 1, a computer-type device 10 is shown having a display 12. The computer-type device 10 is assumed to be configured appropriately to function in a computer-telephony environment and is associated with a telephone terminal (not shown).

The computer-type device 10 shown in FIG. 1 has a Windows™-type operating system. The display 12 shows an application window 14 in which a document is open displaying textual information. In FIG. 1, the following text string is shown as an example in the window 14:

“BlahBlahBlah blah blblah

01234 56789(TAGSYMBOL), FirstName

SomebodySurname

BlahBlahBlah

SW00 ABC Blah Blllah Blaaahh”

In this example, the author intended the displayed text to have no additional formatting. However, the Smart Tag™ scheme provides additional formatting to indicate that links are available to certain applications which are associated by the Smart Tag™ to a particular text-string. For example, the following text strings have additional formatting in FIG. 1: a telephone number “01234 56789”, an entities name “FirstName SomebodySurname” and a post code “SW00 ABC”, which are all underlined. In additional, the text “01234 56789” is associated with a Smart Tag™ symbol or icon 16 as shown in FIG. 1. The text content has therefore been distorted from the original text content.

If a user activates the Smart Tag™ 16, for example, by clicking on the icon representing the Smart Tag™, a drop-down menu of options can be presented to the user so that the user is able to indicate the appropriate context of the text which has been tagged and to ensure that an appropriate application is associated with the tagged text. The tagged text is then provided as input into the Microsoft Exchange server 18 which provides the tagged text as input into another application. For example, if the tagged text is a telephone number, the Smart Tag tags the text and passes this to the Exchange Server 18. The Exchange Server 18 can then recognise from the Smart Tag™ the context of the text has (a telephone number). The user can then activate a dialler application 20 associated with this text via a drop-down menu presenting one or more options, for example, the user could be presented with the option of activating an office phone conferencing gateway application (OPC G/W) 22 to call the telephone number via an appropriate public exchange (PABX 24).

Several embodiments of the invention will now be described with reference to the remaining drawings. Those skilled in the art will realise that the embodiments are by way of example only, and that where it is apparent to those skilled in the art that no conflict would otherwise, certain features described in the context of one embodiment can be included with features described in relation to other embodiments of the invention.

FIG. 2a shows a computer-telephony environment within which a method of integrating communication means according to the invention can be implemented. FIG. 30 shows a user terminal 30 comprising a computer-type device adapted to be capable of utilising one or more communications links over a communications network 44. For example, the user's computer terminal 30 may be associated with a telephone terminal 40 in the computer-telephony environment and be able to connect with communications network 44 via a PABX 42 as shown in FIG. 2a.

Alternatively, PABX 42 may be unnecessary in some embodiments of the invention. For example, the user could wish to communicate only with another entity/entities within an intranet type environment.

The terminal 30 can comprise any device capable of supporting the computer-telephony integration technology of the invention, for example, a personal computer, a client terminal remotely connected to a server system, or a mobile/portable device, for example a portable computer or a personal digital assistant etc. The terminal 30 has an operating system within which a plurality of applications is able to be simultaneously active (and/or open).

In FIG. 2a the operating system is a Windows-type operating environment. Display 32 shows a three applications provided in open windows 34, 36, 38. The window shown contain main application 34, communications integration application 36 and communications application 38. Main application 34 comprises an application within which content is displayed to a user on display 32. Communications integration application 36 comprises an application arrange to associate data-types identified in information selected by the user from the content displayed in main application 34 which the user has pasted to a memory store which can be shared by applications in the operating system. Communications application 38 is an application which supports communication to an entity using an appropriate means. The communications application can comprise a telephone dialler application, an electronic mail application, an application arranged to enable the user to send a short message service text message to a device, an application arranged to provide means to send facsimiles (for example using an appropriate telephone dialler application or using other means), a word-processing application having a letter-writing facility etc., etc.

Main application 34 may comprise any application presenting textual information to the user from which the user can select text to copy to a shared memory store. The textual information is considered to comprise primarily alphanumeric information comprising strings of text which can be stored in the shared buffer. For example, main application 34 may comprise a web-page browser presenting a web-page of information, or a word-processing application, any document display application from which textual information can be extracted to the shared buffer (for example, such as a PDF file-type reader or other file-reader), an electronic mail application, a data-base or spreadsheet application, etc., etc.

The shared memory store, effectively a shared or common buffer between applications, enables the communications integration application 36 to be provided with textual information input which is limited to input over which the user has control. For example, in embodiments of the invention where the communications application 38 and the communications integration application 36 and the main application comprise applications within a Microsoft™ Windows operating system, they should be configured to have the ability to write/read to a shared” buffer such as the “Clipboard” application of the Microsoft™ Windows operating system. Alternative embodiments of the invention may involve devices with other operating systems, for example LINUX, UNIX or UNIX X-Windows type operation systems, which can provide other memory storage facilities which can be shared between several applications.

FIG. 3a describes the steps in essential features of a method of integrating communication within a computer telephony environment. In FIG. 3a, it is assumed that the communications integration application 36 arranged for use in a computer communications environment and comprising means arranged to read information stored in a shared buffer, and means arranged to process said information to determine if the information can be determined to comprise one or more of a plurality of data-types is running in the background when the user opens the main application 34.

In FIG. 3a, the main application presents textual information content to a user (step 50). The presentation of the textual content can be provided by any suitable main application, for example, when the user opens a document or creates a document in word processing application, or accesses a web-page using a browser, or opens an electronic mail message in an electronic mail client terminal application. The information may alternatively be automatically presented to the user.

The user then selects certain text information and stores this selected textual information in the shared memory (or equivalently the shared buffer) (step 52). The communications integration program then reads the text content stored in the buffer and copies the text content to its own memory for processing to determine if at least one data-type can be identified in the information the user has selected (steps 54, 56). If some part of the text can be identified as comprising text having a format conforming with a format expected for a certain data-type or can be otherwise identified as related to a communication-related data-type, a pre-determined communications means is associated with that portion of the selected text comprising the identified communications-related data-type (step 58). Once a communications application has been associated with the text associated with an identified communications data-type, the communication integration application provides appropriate input to the communications application (step 60) to automatically initiate communication with an entity using the associated communications application (step 62). Alternatively, the communications integration application can provide a prompt to enable the user to control the activation of the associated communications application (not shown).

The text the user selects may not therefore be identified directly with a communications-related data-type, but it may instead comprise another type of data-type which then requires associating with a communications-related data-type and an appropriate communications means. For example, if the text selected by the user is person's name, then this can be identified by the communications integration application interfacing with one or more predetermined databases and finding a match for the text the user has selected. The database then enables the communication integration program to identify this text as having the data-type “EntityName” for example. To enable the user to communicate with that person, the communications integration application may be provided with a record information from the database to indicate communication related information. For example, the communications integration application 36 might interface with a telephone directory type database which contains records associating names with telephone numbers. The telephone number for an entity is then determined to comprise a communications-related data-type and the communications integration application can provide the text information comprising the telephone number as input into an appropriate telephone dialler application.

Accordingly, the communications integration application can interface with one or more data-bases to determine if the user selected text comprises a string which is identifiable as conforming with a certain data-type comprising part of a record of one of said-data-bases. If the user selected text can be determined to contain a recognisable data-type, then this data-type may be directly associated with a communications means. If not, or the if communications integration application has been configured to determine more than one means of communicating with an entity, the text comprising the identified data-type is associated with one or more communications-related data-types.

In FIG. 3B, steps in a method of integrating communication in a computer-telephony environment are shown for an embodiment of the invention where the communications integration application 36 has been configured to determine additional information if a data-type is identified from the user selected text. In FIG. 3B, more detail is shown of step 38 in FIG. 3A. In FIG. 3B, steps retain the same numbering where appropriate as that used in FIG. 3A. Thus steps 52to 56 in FIG. 3A are shown in equivalent steps 52 to 56 in FIG. 3B. However, once the data-type of the information the user has selected has been identified in step 56, the communications application determines in step 70 that even if a communications application can be directly associated with the data-type identified (step 74), if other information can be associated with the data-type, this additional information should be determined, which may enable other data-types associated with communications means to be determined (step 74). Similarly, if the data-type is not a communications-related data-type, then additional information should be determined if possible from the data-type to enable the data-type to be linked to a communications means (step 74). This additional information, for example, could comprise determining the name of an entity whose telephone number the user has selected and presenting this to the user as the communications integration application automatically dials the selected telephone number. Alternatively, where the communications application has been configured to identity more than one communications-related data-type, the user could be presented with a plurality of options to select how to communicate with the entity associated with the text the user has selected. Alternatively, the communications integration application could be configured to automatically initiate communications applications to communicate with the entity associated with the text the user has selected using a default communications means or by initiating each communications means in a predetermined order.

The communications integration application 36 may be provided with a means for a user to configure a preferred form of communications, or a predetermined order in which communications means are to be invoked using communications applications. These user preferences may be provided as a communications profile which the user or another party is able to configure.

The communications profile may comprise a set of criteria or rules indicating the type of data-types to be identified, and what type of data-types are to be communications-related data-types. The communications profile may provide further communication rules to facilitate the manner in which communications applications are activated by the communications integration application. For example, the communications profile may provide a rule that more than one form of communication should be associated with certain data-types, and prioritise which form of communication should be presented to the user.

Once certain data-types have been identified in the text the user has selected, the communications integration process can associate the specific text selected with a predetermined communications application for that data-type. For example, if a telephone number is identified, then the communications integration application 36 can associated this directly with a communications application 38 providing a means to communicate using the telephone number.

As shown in FIG. 3B, the communications integration application can be configured to provide additional processing of any text identified as conforming to a predetermined data-type to determine additional communications-related or non-communications related data-types. As an example, data-types which can be directly associated with a means of communication include telephone numbers (including telephone numbers associated with facsimile machines and telephone numbers associated with mobile telephone devices to which both voice and electronic mail and messaging services may be directed, electronic mail addresses, postal mail addresses etc.). However, if a data-type has been associated with, for example, one or more adjacent words whose first letters are capitalised, no direct association with a means of communication will be found by the integration application. Accordingly, as FIG. 3b shows, in such embodiments of the invention where the communications profile for the communications integration application results in the communications integration application identifying data-types which are not directly associated with a communications application (step 76) or where the profile indicates that more than one means of communication needs to be determined or that other further information should be associated with a data-type where possible (step 78), the communications integration application is configured to determine additional information from a given identified data-type (step 82).

Thus, for example, if a text string is identified as a telephone number, but the user has configured the communications integration application to always automatically open an email for any entity identified from selected text, or to present the user with a list of one or more entities identified from the selected text which if the user clicks on will open an e-mail application to contact that entity, then the communications integration application will automatically interface with one or more databases to determine an e-mail address associated with the telephone number.

As another example, if a text string is identified as a telephone number, but the user has configured the communications integration application to always automatically open an email for any entity identified from selected text, or to present the user with a list of one or more entities identified from the selected text which if the user clicks on will open an e-mail application to contact that entity, then the communications integration application will automatically interface with one or more databases to determine an e-mail address associated with the telephone number.

The integration process repeats this process for each identified data-type found in the shared memory store, and can present this in an appropriate form on screen 32, for example, in a drop-down menu or list type format which is displayed to the user on the screen 32 which the user could simply activate by clicking on a prompt with a mouse.

In this way, Once the Communications integration application has processed the information to determine its data type, it can determine to what entity the information relates, and if necessary further process the information to correlated different data types with each other. For example, referring now to FIG. 4 of the accompanying drawings, consider where the name of an entity has been determined by the communications integration application (step 90). The communications profile used to configure the communications profile ensures that several alternative means of communication are always to be determined whenever possible (steps 92, 94). Accordingly, the communications integration application interfaces with one or more databases (steps 96, 98, 100) to determine telephone numbers, including a fax number, and an electronic mail address for the entity.

This information can be provided by using the original data-type for “entity-name” say to determine a telephone number, and then using the data-type associated with the telephone number to determine further information, such as a fax telephone number etc. In this way, it is possible for the communications integration application to step through the various data-types identified with a means of communication dynamically as they are determined and to use this additional information to determine other data-types associated with a means of communication in other data-bases. In particular, for example, an employee identifier number could be used to look up an employee name, and the employee name used to determine a telephone number. Alternatively, the telephone number could be an internal telephone number, and the internal telephone number used to identify from an appropriate database what the external telephone number is.

The data-types selected all provide means for the user to contact an entity associated with the information using the data type to which the information has been associated.

Data-Type Identification of User Selected Text

The communications integration application processes the user selected text written to the buffer content information by copying the buffer contents and then determining if the text can be directly identified from internal processing rules or if the communications integration application needs to interface with a data-base have records which contain one or more data-type information related to entities. If the communications integration application cannot directly determine the data-type of the text information, then the text information may be compared with the text found in the records of one or more databases to determine if a match exists. If a portion of the text the user has selected can be matched to a portion of text held in a database record, then the database record text data-type can be used to identify the data-type of the corresponding portion of text the user has selected.

Where the communications integration application directly determines a data-type, this can be done using a set of semantic rules to determine if a particular item of information (for example a text string or series of text strings) in the user selected text comprises a particular communications-related data-type (e.g. telephone number or address) or a data-type related to an entity's information (a person's name) etc. Other rules can be set by the user to ensure that certain data types, although recognised as being present in the user-selected text are not subject to further processing and/or are discarded. For example, the user may not want the communications integration application to process information to determine if it comprises a post-code when a text string of such information has been included in the information written to the shared buffer by the user.

Activation of the Communications Application

Once the communications integration application 36 has determined the type of information, it can determine what communication or other application is suitable for use with that data type to enable the user the communicate with one or more entities associated with information the user has copied to the shared memory. For example, if the user copies a number of telephone numbers, then the communications integration application 36 could present a list of these telephone number along with a history of other telephone numbers identified as being associated with a communications application comprising a dialling application to the user. Any repeat entries for the same entity could be automatically deleted by the communications integration application and/or the communications application. In this way a user could selected several entities to be communicated with at the same time, for example, by conference calling in several parties or by e-mailing, faxing, or short message service texting a plurality of entities with the same communication. Such embodiments of the invention are usually such that the communications application will provide the user with a list to function as a prompt for the user to control the initiation of any communication application.

FIG. 5A shows an example of such an embodiment, where the communications integration application presents the user with a series of means of communicating with an entity whereas FIG. 5B shows a number of entities which can each or collectively be called by selecting the telephone number provided in the displayed list (which are shown as underlined to indicate that by clicking on them, for example, or by highlighting one or more telephone numbers, a dialler application will be appropriately configured by the communications integration application to contact the entity/entities the user has selected).

In each of these embodiments, the user can then control activation of the communications application 38, in this example by the telephone number can be dialled by the user clicking on the number in the list or otherwise activating the dialling application

In embodiments of the invention where the communications application 38 comprises one or more programs arranged to automatically initiate communication without further action by the user, the user can select text containing one or more entity names and then a conference call could be automatically initiated between the entities identified from the user selected text without the user needing to take further action.

Information Selection

Where the operating system is Windows™, those skilled in the art will be aware that a variety of techniques are available to select text and copy this into a shared buffer (a buffer shared between different applications). For example, depending on the operating system and the type of main application 34, the user could select text by highlighting text with a cursor. For example, if the main application comprises a PDF-type file reader/editor application, the user can select to copy this to a Microsoft™ Word™ word-processing application by selecting the copy option in the PDF application. Alternatively, once text has been selected, a key or key combination (e.g. the Control and “C” keys) can be pressed to copy text to the shared buffer store. In this way, the user is able to select text to be tagged without altering the original presentation of the text. Alternatively, text can be “cut” or deleted, and stored in the shared buffer in the same way. There is no need to provide text in a specific format or present it in a specific main application, any text in any form in any document which can be copied to the integration application, for example, by the user selecting the text and copying it to a shared buffer application, can be used.

Communication Integration Application

The communications integration application 36 can considered a background application in this embodiment in the sense that it comprises an application which runs automatically in the background (for example, it could be associated with the operating system once installed or an application which automatically runs when any text-display application is opened). In alternative embodiments, however, the Integration Application 36 could also be an application which requires activation by a user before being operational. Whilst the communications integration application 36 shown in FIG. 2a is shown in a separate window which can provide a user interface enabling the user to configure a communications profile, in alternative embodiments, this interface may not be provided to the user. For example, where the communications integration application 36 is an application which runs in the background, unless an interface is actively opened by the user to enable the communications integration application to be appropriately configured, the communications integration application program does not need to be represented by a window permanently open on the display 12.

The Integration Application 36 is preferably configured so that its operation does not disrupt the operational flow of the main application 14 within which the user is currently active. Once data-types have been associated with a means of communication the Integration Application 36 then activates a suitable application to initiate appropriate communication between the user and the entity.

The invention enables links to be automatically created between any applications regardless of type. The text which is used to facilitate the communication is copied to a buffer which ensures the original document maintains the form the author intended. A user can specify just a subset of the textual content of the original document to be processed for associating with a communications process. Where both image and text content are present in the shared buffer, the communications integration application copies only the textual content for the identification of data-types contained within.

Advantageously, the user is able to select the textual information to be scanned for data-type identification. Consider when a large document which might otherwise generate several hundred list items of possible entities to contact such as a web-page showing a number of names corresponding to people in, say, a conference photograph. Instead of generating a long list of names and a number of ways to contact them, the user is able to highlight just one name. Providing the user has already pre-configured their system and the computer application (termed hereinafter the “communications integration application”) which performs the processing of the buffer contents appropriately, a dialling program can automatically open to call that person without the user having to take any further action.

Thus the invention seeks to provide a computer application which comprises an intelligent buffer reader and means to perform steps in a method of automatically resolving information read from a buffer to determine a means to communicate with an entity. Particularly, but not exclusively, selected information can be associated with a means to communicate with an entity or determined if it relates to a communicable entity. Once the information has been identified with a predetermined data-type and associated with a particular means of communication, a user can be presented with the means to communicate with the entity.

Advantageously, a method of automatically searching a buffer for information conforming to a set of user-defined rules using an application which runs in the background of whatever actions the user is performing in another particular application is provided. For example, the user is able to select some text and copies it in a word-processing application. The communications integration application reads the buffer into which the text has been copied. The communications integration application processes the text according to a set of predetermined rules and categorises the text as a telephone number. If the only text selected is a telephone number, the communications integration application can be configured by the user to automatically forward the telephone number as input into another application which is able to dial the telephone number. The user therefore does not need to take any other action to dial the telephone number other than select the telephone number to be dialled.

Alternatively, if the user selects an email address and copies this into the buffer, the communications integration application could process this text and recognise that this is an email address and automatically open up an email client application, and present the user with an already opened “new e-mail” environment in which the address to which the email is being sent comprises the text the user has selected.

Alternatively, the communications integration application may cause the application which enables the user to communicate with the entity by operating suitable selection means, for example, by selected by copying corresponding text to be presented to the user in a list or menu type form so that the user can select to communicate with them. Preferably the selection means is activated by a single action, for example, if the selection means comprises a cursor type feature, the selection is activated by a key or key combination being pressed, or where the selection means comprises a mouse, trackball or pointer-type device or the like in conjunction with a cursor or other means selecting the communication option, the single action comprises a single click of an appropriate button or key/key combination being pressed.

In other embodiments of the invention, where the user has selected a range of text which may correspond to one or more communication option for one or more entities, the user is presented with a list of entities and one or more associated means to contact them using such selection means.

The communications integration application is triggered by the detection of new content in the common buffer. Once new content has been detected, the background information processes the content information automatically to determine what type of information is being presented. This categorisation of information can be done according to the applications with which the information is to be associated and/or to enable cross-referencing between various categories of information. For example, if the person has selected an email address but only a telephone dialling application is set to receive input from the communications integration application, then the communications integration application may associate the email address with an entity and then determine a phone number from the entity which can then be provided to the dialling application. The process may be such that by selecting an email address the person is automatically dialled without further action by the user or the process may alternatively present the user with the entity details and present an option to dial the entity.

The process of determining the category of information in the buffer and any other relevant information associated with the information in the buffer is started automatically as soon as a user has selected certain text. Accordingly, there is no need for the user to paste or drag-and-drop the selected text as input into another application via an appropriate user interface.

The selected text is processed by the application in the background to determine certain relevant criteria to enable a user to communicate with an entity identified by the information retrieved from the buffer contents. For example, the user may select in text presenting a telephone number associated with a person in a specific application. The user may have selected that the communications integration application automatically present a list of options representing an entity's name and associating with the name one or more communication options, for example, one or more telephone numbers, one or more electronic mail (e-mail) addresses, messaging (e.g. instant messaging) addresses. The user may associate with each of these a preferred application. The communications integration application may be arranged to generate a second communication option from a first communication option associated with a person.

Advantageously, the invention enables a user to define the rules for selecting text strings which are used to look-up communication options within one or more directories. The user is also able to select a default application to be associated with each type of text string and/or communication option. In this manner a user is able to select a telephone number text string. An option to email an entity associated with the selected telephone number can be automatically presented to the user, preferably via a user interface in which the user can trigger an interface for generating an email addressed to the user via a one-click option on the interface.

This assumes the user already has provided authentication details for the email application to be used to send such an email where appropriate.

### Other Embodiments of the Invention

For example, consider the textual information displayed in main application 34 as shown in FIG. 2a and FIG. 2b, which is as follows:

“BlahBlahBlah blah blblah

01234 56789, FirstName

SomebodySurname

BlahBlahBlah

SW00 ABC Blah Blllah Blaaahh”

The user selects text, preferably text comprising a portion of the document generally significantly less than the entire document contents open in the main application. As shown in FIG. 2b, for example, “01234 56789” is shown selected by the dotted rectangle and this text is the only text copied to a shared memory store application (not shown).

The communication integration application 36 then extracts the text “01234 56789” from the shared buffer into its own memory. Once extracted where the text is then processed in a first stage to determine what data-types are present in text copied by the user into the buffer. The technique used to determine what data-types are present in the text can be any suitable technique. For example, a technique such as Rossman et al, or those described hereinabove with reference to applying semantic rules and/or comparing the selected text with the text content of the records held in one or more databases with which the communications integration application is configured to interface with.

Consider if the text the user selects comprises all the text shown in the document displayed in main application 34 of FIGS. 2a, 2b and copies this to the shared buffer. The communications integration application 36 then copies the content of the shared buffer into its own memory store where the content is analysed to determine its context and semantics. For example, as shown in FIG. 2a, the Application 14 shows certain text and the user has selected the text “BlahBlahBlah blah blblah 01234 56789 FirstName SomebodySurname BlahBlahBlah SW19 IIT Blah Blllah Blaaahh” and copied this to the shared buffer. The contents of the buffer which has just been written to therefore contains the text “BlahBlahBlah blah biblah 01234 56789 FirstName SomebodySurname BlahBlahBlah SW19 IIT Blah Blllah Blaaahh” which includes several possible data types, of which one data type 48 shown in FIG. 2B comprises a telephone number.

In the example shown in FIGS. 2a and 2b, several data types are contained in the text copied to the shared buffer—a person's first name and family name, a telephone number and address information (a post or zip code), and which data-types are identified can be determined by appropriately configuring the communications profile (for example, the user may not want to identify mobile telephone numbers or postal address related information). For example, if the communications integration program has been appropriately configured, then from this text the string of text “FirstName SomebodySurname” could be identified as a first entity name having a non-communications related data-type. Another data-type could comprise an entity's telephone number, here the text string “01234 56789” found in the text.

Thus the communications integration application can be configured to determine what data types are present using a set of pre-determined criteria so that any unselected or unrecognised data types are ignored. For example, a telephone number, a first name, a surname, a post-code (or equivalently zip-code) may be resolved from the contents of the shared buffer by the communications integration application 36 in the example shown in FIG. 2a. If however, the selection rules were set so that only telephone numbers were identified, only the “01234 56789” text string would be identified. If certain identified text (such as the data-type corresponding to the post-code text) was found to correlate to several possible entities, then it might be ignored. In addition, these data-type selection rules can be either a default set or selected by the user according to their own preferences (for example as a communications profile to be used by the communications integration application. Other user selected textual information copied to the shared buffer may be processed by the Communications integration application 16 to resolve data types such as a web-page Universal Resource Locator (URL), an electronic mail address, etc. More than one item of information of each type may be present in the user-related text. If the communications integration application 36 is configured to determine data-types which are not directly associated with a means of communication, for example, for example where a data-type comprises an entity name (for example a person or corporate name), then further steps are required as were outlined above to determine how to communicate with the entity. Where further information is required, the communications integration application is configured to consult certain databases. The databases can be predetermined in accordance with a communications profile established for specific data-types by the user.

One or more suitable communication means for the user to contact that entity can be determined, depending on what databases the Communications integration application has been configured to interface with. For example, if the communications integration application interfaces with a database having “phone book” or “directory” types of records, then the user selected text may include information may be identified as a telephone number. The type of phone number may be indicated by the database consulted, for example, it may identify the telephone number is a fax number or mobile number, or an internal number.

Alternatively, if the user selects a telephone number, the communications integration application could return information on the entity associated with the telephone number and/or further telephone numbers associated with the entity such as a mobile telephone and facsimile number if these are indicated a database (which may be the same database but need not be). In this way, the communications integration application is configured to associated information located in the data-type records of one or more databases to determine data-types and communications-means which can be associated with certain data-types recognised from the user selected text. This enables a data-type corresponding to a fixed telephone line telephone terminal to be associated with an electronic mail address, a mobile communications device address or telephone number, etc etc.

Communication Method Priority

Where several means for communicating with an entity associated with a data-type are determined, a priority for the method of communication may be established by the user in the communication profile.

The communications integration application may automatically cause the telephone number to be called, or alternatively present this information to the user in the form of a list indicating the entity's identity and the phone number to contact them. The user can then choose to contact that person directly by simply activating the dialling application (for example by clicking on the entity or phone number as displayed). Alternatively, the Communications integration application could associate the entity with more than one possible means of communication, in which case the Communications integration application could present the user with a choice of communication options (for example, email, telephone, fax, small message service text, instant messenger message, etc) associated with communications-related data-types identified using one or more database records.

In this way, it is possible for the communications integration application to provide a very sophisticated set of options for a user to communicate with an entity in a very seamless and non-intrusive manner. For example, the application 36 can determine that textual information selected by the user contains a text-string belonging to a certain data-type which indicates it corresponding to an email address and yet be configured to call the entity whose email address the user has selected using one or more appropriate database records to associate the e-mail address with a telephone number for the same entity.

It should be noted that the term communications integration application is referred to as a single computer application, but may comprise a suite of one or more computer programs distributed into a number of components which collectively provide the ability to cross-correlate data-types with each other and alternative means of communication. Thus a user can, for example, paste a person's email address when editing a word processing document into the shared buffer. The communications integration application then can cause a dialling application to immediately call the person whose email has been pasted by the user to the buffer. Alternatively, the Communications integration application can present the user with the option to activate the dialling application.

In another embodiment of the invention, the communications integration application provides the user with the option to contact an entity either at a later point in time using a default communication means or to select from a plurality of communication means, subsequent entities will appear in “list” type presentation.

To ensure that redundant information is not written to the list (i.e. to remove entries which would otherwise repeat within a set number of entries (i.e., to prevent the list from being populated with 10 entries all related to one person and containing the same information), the communications integration application 36 checks if the data-type of the information has already been correlated to other entity related information already stored in a form which the user can easily activate in the list. For example, the Communications integration application may have already associated a telephone number with a particular entity's address by referring the information identified as a telephone number to a suitable database having records which correlate a person's name to a telephone number. If the Communications integration application 36 then determines that information recently written to the shared buffer comprises a telephone number data type and determines that this second telephone number relates to the same person's name, then the Communications integration application can be set to either present these two numbers in such a context that the user is aware they are related, regardless of any intervening information which may be identified, or to suppress one in favour of the other (for example, to always dial a land-line number first, or always dial a mobile number first etc).

In other embodiments of the invention where the communications integration application 36 is be configured to interrogate one or more databases to determine what information is identified, the communications integration application 36 is configured to interface with search means provided on a remote server and/or means to search for information over a communications network to determine the data type of the information in the shared buffer. A user may select one or more databases to be used by the communications integration application to determine what type of information the data is, and/or to associate the information determined with other entity related information and/or communication means, and a hierarchy of databases may be established. For example, the communications integration application could interface with a corporate intranet telephone directory first and subsequently consult a public telephone directory to determine a person telephone number.

As has been mentioned above, once the communications integration application 16 has determined the data type and associated it with a form of communication, a suitable application to provide communication in the determined form can be activated either directly by the Communications integration application or partially activated so that communication can be effected by the user activating the application manually. For example, manual activation of the application by the user can be effected by the user clicking on a telephone number where the application is a dialling application such as is described in the US Patent No. U.S. Pat. No. 6,594,357 and references cited therein.

A user can configure the communications profile used by the communications integration application so that in the event the first means of communication activated does not enable the user to contact an entity; further means of communication are initiated automatically.

For example, in FIG. 6, the communication integration application has automatically dialled a telephone number associated with an entity (step 110). If the number is busy or not answered, the appropriate signalling is detected and the communication integration application activates a second means of communication, in FIG. 6, this is a mobile telephone number which is dialled for voice communication (step 112). If a busy number is obtained, then this signalling is again detected and the communications integration application could be configured to prompt the user to send a text message to the mobile telephone number. Alternatively, if a no answer signal is detected, then the communications integration application is configured to prompt the user to send an email. The email client can be opened, and the user may be invited to record a voice message to be sent as a file attachment (in which case another suitable application may be required). Alternatively, the user may wish to record a voice message but have this converted into text using a suitable application. Alternatively, the user may wish to simply enter a text message. Alternatively, the user may chose to close the email application in which case a word-processing application may automatically open and be configured to present the user with a fax cover sheet to enable a fax to the sent to a fax number associated with the user.

Advantageously, by enabling a user to specify which databases are to be interrogated, if the text written to the shared buffer is determined to be a telephone number, the communications integration application can further determine to whom the telephone number relates, and can also, if such options are available to, determine an email address for the person/entity associated with the telephone number to be activated in the event that a user is not able to successfully contact the entity using a first selected.

The result of the processing is that the communications integration application will present the user with a list of entities which may be individuals or corporate entities or other organisations etc, and with a range of possible communication options to contact each entity (such as FIG. 5A shows for a single entity #1). A user can then select how to contact one or more entities on the list, for example using a single click to select the text associated with the appropriate means of communicating with an entity. For example, the user can click on an email address to email an entity or a phone number to phone the entity.

For example, consider where a user selects information comprising a single data-type and copies or cuts this information so that it is stored in the shared buffer. The communications integration application 16 can identify this information as comprising a certain data-type and be configured can automatically trigger the appropriate Communication Application 38 to perform a default communication action associated with that data-type. This is suitable if a user selects a name or a telephone number and places this into the buffer.

The user may know in advance that they will only want to contact people by telephone, in which case the communications integration application 38 could be configured to interface with appropriate database records to determine from the name an appropriate telephone number which is fed into a dialling application.

Alternatively, the Communications integration application may directly input the telephone number selected into the dialling application. The dialling application then directly dials the telephone number indicated without the user having to perform any further action beyond the initial paste step.

Advantageously, the removal of redundant information from the list enables the user to arrange conference calls by simply selecting a number of entities to be dialled using another appropriate application, and the communications integration application will provide the appropriate details to the dialling application.

The term “communications integration application” has been used above to clearly identify the computer application comprising the invention, and, especially when the user is operating a computer terminal in a distributed computing environment, may in fact comprise a suite of more than one computer programs which may be distributed over a plurality of system devices. In some embodiments of the invention the “communications integration application” may run automatically whenever the computer terminal the user is operating is switched on, but in other embodiments it may require manual activation by the user. Thus the “communications integration application” does not need to be an application always running in the “background” of the operating system in some embodiments of the invention.

As has been described above, advantageously, the “communications integration application”) enables a user to select an email address and simply choose to copy this. No action needs to be taken by the user beyond the step of copying. The user may choose not to communicate at all with the entity whose email address was selected, in which case this information can be retained as history information in a list. The name of the person who's email address corresponds to the selected information could be displayed in the list which would present the user with the opportunity of dialling that person with a single click, or if more than one entity/email address were selected from the list then the user can email several people at once in a very simple manner. This greatly facilitates the ease with a user in a business environment can contact various entities. The lists of stored integrated communications links provided by the integrated communications application need only to display to the user an indication of the entity each stored integrated communication link relates to and what means of communication would be activated if the user were to activate that communications link.

Another embodiment of the invention extends to a user seeking to contact a person by telephone and leaving a message. The communications integration application records the message as it is left and the user can simply select to email the person they were originally trying to contact rather than leave a voicemail message on that person's telephone. This message may be emailed in a text form if the user's client terminal is equipped with a suitable speech recognition application or alternatively simply sent as an audio file attachment to the email. In one embodiment of the invention, if the called telephone number does not answer, or if the user selects a record button at any point during the telephone conversation, the Communications integration application records the user's speech (and the speech of the other party if the user selects to record this). The user can then send this recording as a text message or as an email with an audio file attachment to the called entity, or retain the recorded speech on their machine.

It is possible to configure the Communications integration application to automatically switch to a record a message mode if the called entity does not pick up. The communication operation selected by the user is preferably activated by a single action by the user, such as, for example, a voice command, a mouse-click, a pressing a key on a keyboard etc. If a person wishes to communicate with several persons simultaneously, for example, by a conference call or email sent to a plurality of different email addresses, the user can simply select the respective list entries with whom they wish to contact, and the Communications integration application then provides this information to a suitable communication application 18 which then initiates a conference call by dialling the various numbers and/or which presents the user with an email addressed to the multiple email addresses as appropriate.

The invention thus enables a user to selectively determine which information is to be used to communicate with an entity, the number of entities for which communication information is to be determined at any one time, and enables the user to define certain defaults to ensure that communication can be automated appropriately. This enables a user to simply copy a telephone number to a shared buffer after which the communications integration application is configured to determine appropriate information to identify the context of the text-string the user has copied and to automatically dial the number so identified using a dialling application appropriate for the computer-telephony environment.

The text of the abstract is hereby incorporated into the description:

An integrated communications application reads information copied to a shared buffer by a user from another application. The information copied can comprise any format and can originate from any application from which the user can paste information. In this way there is no restriction on the source of information. The computer application reads the buffer and copies the information so that it can subsequently process it to determine if it conforms to a predetermined data-type. One or more means to communicate with an entity whose address corresponds to the data-type are then determined from a single data-type. This enables the application to revert to an alternative means of communication automatically if the means first used to try to communication with the entity is not successful. More generally, the computer application is arranged for use in a computer communications environment and comprises: means arranged to read information stored in a buffer, the buffer arranged to be shared between a plurality of applications in said computing environment; and means arranged to process said information to determine if the information can be determined to comprise one or more of a plurality of data-types.

Whilst the above embodiments have referred to information, in particular, text-strings and/or textual information, those in the art will appreciate that any data-structure which can be represented in such a way that a user can select it from a display can be copied to the buffer (i.e., the shared memory facility). Thus the copied information can comprise one or more items of text and/or images and/or audio information which is capable of being processed in the buffer facility. Once copied to the buffer facility, the information can be associated with an entity and/or a communications address for an entity. Once associated with a communications address, an appropriate communications mode can be determined for communicating with the entity.

1-47. (canceled)

48. An integrated communications application arranged in use to associate one or more means of communicating with one or more entities with selected information included within a range of information selected by a user in another application operating in the same environment as the integrated communications application, the range of information having been copied by the user to a shared memory buffer, wherein the other application is configured to at least write to the said shared memory buffer and the integrated communications application is configured to at least read from the said shared memory buffer, the integrated communications application further comprising:
means arranged to extract said selected information from within said range of information stored in the shared buffer; and
means arranged to process said extracted information to determine if the selected information included within said range of information selected by the user comprises one or more of a plurality of data-types.

49. An application as claimed in claim 48, wherein a said one or more of a plurality of data-types comprise communications-related data-types and are associated with means to communicate with said one or more entities.

50. An application as claimed in claim 48, wherein a said one or more of a plurality of data-types represent a data-type which is related to an identifiable characteristic of an entity.

51. A method communicating with an entity, the method comprising:
a user operating a terminal to open an application which displays textual information on a screen;
the user selecting a range of text from the displayed textual information;
the user copying the range of text to a buffer available to at least one other application;
determining if a text string within the range of the text in the buffer conforms to a predetermined data-type associated with an entity; and
in the event the predetermined data-type associated with an entity comprises a communications-related data-type associated with an identified means to communicate with the entity, initiating communication with the entity using said means to communicate; and
otherwise if the pre-determined data-type comprises a data-type which is not related to a means of communication, determining an associated communications-related data-type for the entity and initiating communication with the entity using a predetermined means to communicate associated with the associated communications-related data-type.

52. A method as claimed in claim 51, wherein in said step of determining if the text-string conforms to a predetermined data-type, the text-string in the buffer is read and another application determines if the text-string conforms to a predetermined data-type associated with an entity.

53. A method as claimed in claim 52, wherein the buffer contents are read and copied by said other application into its own memory means.

54. A method as claimed in claim 51, wherein the step of initiating communication with the entity using said means to communicate comprises automatically using said means to communicate without further action by the user.

55. A method as claimed in claim 51, wherein the step of initiating communication is controlled by the user performing an additional action.

56. A method as claimed in claim 51, wherein the predetermined means to communicate are configured such that either:
a set of predetermined preferences are established by the user which are used to determine a default predetermined means to communicate with the entity; and/or
a default means of communication is determined by the user.

57. A method as claimed in claim 48, wherein the method further comprises a step of associating the means of communication determined from the data-type with another means of communication, and in said step of initiating communication use said other means of communication.

58. A method as claimed in claim 57, wherein instead said means of communication are first initiated, and only if said first means of communication is not successful in enabling the user to communicate with the entity is said other means of communication automatically initiated.

59. A method of enabling a user to select an action to be performed on information included within a range of information selected by the user, the method comprising the steps of:
the user selecting the range of information; and
automatically determining if within the range of information, some information conforms to a predetermined set of format rules;
processing the information items conforming to said predetermined set of format rules;
associating each said one or more processed information items with one or more communication options;
associating each communication option with an application enabling said communication option to be activated.

60. A method as claimed in claim 59, wherein said communication option is activated by a single user-determined action.

61. A method as claimed in claim 60, wherein said single user-determined action is taken from the group consisting of:
a single activation click by a computer mouse-type device;
a single key press on a computer keyboard;
a single voice command.

62. A method as claimed in claim 59, wherein the user selects the information by storing the selected information in a memory store.

63. A method as claimed in claim 59, wherein the user selects the information by dragging and dropping the information into a suitable application interface.

64. A method as claimed in claim 59, wherein the application enabling said communication option to be activated comprises a click-dial application.

65. A method as claimed in claim 48 wherein each information item is associated with a communication option by reference to a database selected from a set of one or more databases.

66. A method as claimed in claim 65, wherein said communication option is further associated with a second communication option by reference to a database selected from a set of one or more databases.

67. A method as claimed in claim 59, wherein a said information item comprises a telephone number associated with an entity, and said communication option comprises an alternative method of contacting said entity.

68. A method as claimed in claim 67, wherein said alternative method of contacting said entity comprises selecting an action to be performed on one or more of the following information items:
an alternative telephone number;
an electronic mail address;
an instant messenger address;
a postal address;
an instant messaging address;
an internet URL associated with the entity.

69. A method as claimed in claim 68, wherein said information item comprises an entity's name, and said method of communication comprises dialling at least one telephone number for the entity.

70. A method as claimed in claim 59, wherein if said method of communication determines a first means for communication which is not successful, then a second means of communication is determined and automatically activated.

71. A method as claimed in claim 70, wherein said method of communication is determines means for communication which comprise means arranged to enable a user to dial a telephone number for an entity, and if the entity cannot be contacted by said dialled telephone number, the user is prompted to record a message which can be communicated by electronic mail to the intended recipient automatically.

72. A method as claimed in claim 71, wherein the message is converted to text and included in the electronic mail.

73. A method as claimed in claim 71, wherein the message is attached to the electronic mail in an audio format.

74. A method as claimed in claim 71, wherein a list of information items is generated, each information item being associated automatically with at least one means of contacting the entity, whereby the user is able to select an information item and/or its associated communication option and contact the entity by a single action performed on the representation of the communication option provided graphically to the user.

75. A method as claimed in claim 71, whereby a user is able to select a plurality of information items, each item having the same type of communication option and is able to contact simultaneously all entities so selected using a suitably modified version of said communication option.

76. A method as claimed in claim 75, whereby a user is able to select to conference call several entities in a telephone call by simultaneously selecting said plurality of entities with a single action.

77. A method as claimed in claim 76, whereby a user is able to select to electronically email several entities by selecting information whose filtered information items generates an email communication option for said several entities.

78. A suite of one or more computer programs which when executed alone or collectively are arranged to implement steps in a method according to claim 48.

79. A client application comprising software arranged to implement steps in a method according to claim 59 in a distributed computer system.

80. A distributed computer system comprising a client terminal and a database facility, the client terminal being arranged to implement steps in a method according to claim 59, whereby said steps of associated said one or more information items are performed by said client terminal communicating said information items with said database to enable at least one database record structure to be determined associated with a said information item to derive at least one communication options associated by said record with said information item.

81. A method of integrating communication means in a computer-telephony environment, the method comprising:
processing a text-string derived from a range of textual information a user has selected to copy to a shared buffer application;
determining if the text string in the buffer conforms to a predetermined data-type associated with an entity by comparing the text-string with textual information associated with the predetermined data-base, the textual information comprising a component of a record stored in database; and
in the event a predetermined data-type is associated with an entity,
if the data-type is associated with an identified means to communicate with the entity, initiating communication with the entity using said associated means to communicate and the text-string selected by the user; and
otherwise if the pre-determined data-type comprises an identified entity, initiating communication with the entity using a predetermined means to communicate determined by further associating the data-type with a data-type associated with said predetermined means to communicate.

82. A method as claimed in claim 81, wherein a data-type is associated with a plurality of means to communicate with the entity, and each said communication means are initiated in a predetermined order if the first communications means is not successful in establishing communication with the entity.

83. A memory-facility arranged to enable a user operating a user-terminal to communicate with at least one entity using one or more communication means associated with said user-terminal, the memory-facility being arranged to interface with a plurality of applications whose operation is supported by said user-terminal, wherein one of said plurality of applications comprises a communications application arranged to associate one or more communication means with information selected by said user from a range of information provided by one or more others of said plurality of applications, the memory-facility comprising:
memory means arranged to store a range of information selectively copied by the user and written to said shared memory by said one or more others of said plurality of applications; and
means arranged to share said memory with at least said communications application and to enable said communications application to read information from the said shared memory, said read information enabling at least one available communication means to be selected by the communications application to enable the user communicate with said entity.

84. A memory-facility as claimed in claim 83, wherein the read information enables at least one available communications means to be automatically selected by the communications application.

85. A memory-facility as claimed in claim 83, wherein the information selected by the user comprises textual information.

86. A memory facility as claimed in claim 83, wherein the information selected by the user comprises an image.

87. A memory facility as claimed in claim 83, wherein said read information comprises selected information and said buffer facility further comprises:
means arranged to extract selected information from the shared buffer; and
means arranged to process said extracted information to determine if the user selected information can be determined to comprise one or more of a plurality of data-types.

88. A communications application arranged in use for operation on a user-terminal capable of communicating over a communications network with one or more other entities, the communications application comprising:
means arranged to associate one or more means of communicating with one or more entities with information within a range of information selected by a user in another application operating in the same environment, the range of information selected having been copied by the user to a shared memory, wherein said other application is configured to at least write to the said shared memory and the communications application is configured to at least read from said shared memory;
means arranged to extract selected textual information from the range of information stored in said shared memory; and
means arranged to process said extracted information to determine if the user selected textual information can be determined to comprise one or more of a plurality of data-types.

89. A method of communicating with one or more entities using a terminal operated by a user and capable of forming one or more connections to a communications network, the method comprising the steps of:
the user selecting a range of information from a display; copying the selected information to a buffer; processing the information to determine from the context of the copied information, a communications address for each of said one or more entities; and
automatically initiating a communications application associated with each communications address identified, to enable the user to communicate with said one or more entities.

90. A method as claimed in claim 89, wherein at least one communications address comprises one of the following:
an email address;
a telephone number; and
a video-communications address.

91. A method as claimed in claim 88, wherein, the selected information copied comprises a text-string.

92. A method as claimed in claim 88, wherein the selected information copied includes an image.

93. A method as claimed in claim 92, wherein said image is capable of being associated with at least one communications address.

94. An intelligent buffer is provided in which the buffer is arranged to receive a text-string selected by a method according to the previous aspect.
